(19) United States
(12) Patent Application Publication
(10) Pub. No.: US 2026/0035971 A1
(43) Pub. Date: Feb. 5, 2026

(54) DOOR STABILIZER

(71) Applicant: Techtronic Cordless GP, Anderson, SC (US)

(72) Inventor: Trevor C. Fauss, Greenville, SC (US)

(21) Appl. No.: 19/272,369

(22) Filed: Jul. 17, 2025

Related U.S. Application Data
(60) Provisional application No. 63/677,833, filed on Jul. 31, 2024.

(51) Int. Cl. E05C 17/54

(52) U.S. Cl. CPC E05C 17/54

(57) ABSTRACT

A door stabilizer includes a main body and a footrest. The main body defines a footrest receptacle and includes a first end, a second end, a support surface configured to be placed on a surface, and a contact surface configured to engage a door. The support surface extends between the first end and the second end. The contact surface extends between the first end and the second end and extends away from the support surface such that the contact surface is further away from the support surface at the second end of the main body than at the first end of the main body. The footrest is pivotably coupled to the main body and includes a pivot shaft that defines a pivot axis about which the footrest pivots relative to the main body. A portion of the footrest is configured to pivot into and out of the footrest receptacle.

### CROSS-REFERENCE TO RELATED APPLICATIONS

This application claims priority to U.S. Provisional Application No. 63/677,833, filed Jul. 31, 2025, the entire contents of which are incorporated by reference herein.

### FIELD OF THE DISCLOSURE

The present disclosure relates to door stops or stabilizers, and more specifically, a door stop wedge.

### BACKGROUND OF THE DISCLOSURE

Door stop wedges can be used to prop open a door. In most cases, the door stop wedge is placed within the gap between the bottom of the door and the floor. At this point, the door stop wedge is forced into the gap where the door stop wedge is wedged between the door and the floor to maintain the door in an open position. This door is inhibited from closing when the door stop wedge is installed.

### SUMMARY

In one aspect, the disclosure provides a door stabilizer including a main body and a footrest. The main body defines a footrest receptacle and includes a first end, a second end, a support surface, and a contact surface. The support surface is configured to be placed on a surface. The support surface extends between the first end and the second end. The contact surface is configured to engage a door. The contact surface extends between the first end and the second end and extends away from the support surface such that the contact surface is further away from the support surface at the second end of the main body than at the first end of the main body. The footrest is pivotably coupled to the main body. The footrest includes a pivot shaft that defines a pivot axis about which the footrest pivots relative to the main body. At least a portion of the footrest is configured to pivot into and out of the footrest receptacle.

In some aspects, the main body defines the footrest receptacle between the support surface and the contact surface, and the support surface defines an opening to the footrest receptacle. In further aspects, the footrest receptacle includes a pivot shaft receptacle portion, protrusions are formed along the support surface at the pivot shaft receptacle portion, and the protrusions engage the pivot shaft to retain the pivot shaft within the pivot shaft receptacle portion.

In some aspects, the main body and the footrest are sized such that the footrest fits entirely within an outer boundary of the main body when the footrest pivots into the footrest receptacle.

In some aspects, the footrest further includes a tongue portion extending form the pivot shaft and a grip portion at an end of the tongue portion opposite from the pivot shaft. In further aspects, the grip portion includes a plurality of protrusions that improve traction of the footrest. In further aspects, the footrest receptacle is complimentarily shaped to the footrest such that a portion of the footrest receptacle is shaped and sized to receive the tongue portion and another portion of the footrest receptacle is shaped and sized to receive the grip portion, and the tongue portion and the grip portion have different dimensions.

In some aspects, the main body has a body length and a body width, and the footrest has a footrest length and a footrest width. The footrest length is less than the body length, and the footrest width is less than the body width.

In some aspects, the contact surface slopes from the first end to the second end in a direction extending away from the support surface.

In some aspects, the main body defines an aperture at the second end of the main body that provides access to the footrest receptacle.

In another aspect, the disclosure provides a door stabilizer including a main body and a footrest. The main body includes a first end, a second end, a support surface, and a contact surface. The support surface is configured to be placed on a surface. The support surface extends between the first end and the second end. The contact surface is configured to engage a door. The contact surface extends between the first end and the second end. The footrest is movably coupled to the main body. The footrest is moveable between a stowed position, in which the door stabilizer is usable to inhibit movement of the door in one direction, and a deployed position, in which the door stabilizer is usable to inhibit movement of the door in multiple directions.

In some aspects, the main body defines a footrest receptacle that receives the footrest in the stowed position such that the footrest is positioned within the main body. In further aspects, the footrest is positioned entirely within an outer boundary of the main body when the footrest is in the stowed position.

In some aspects, the footrest extends from the first end of the main body when the footrest is in the deployed position such that the footrest increases a length of the door stabilizer. The footrest is configured to extend through a gap between a bottom of the door and the support surface when the footrest is in the deployed position.

In some aspects, the main body defines an aperture at the second end of the main body, the aperture providing access to the footrest receptacle.

In some aspects, a length of the door stabilizer when the footrest is in the deployed position is between 1.2 and 2 times longer than a length of the door stabilizer when the footrest is in the stowed position.

In another aspect, the disclosure provides a door stabilizer including a main body and a footrest. The main body includes support surface that is configured to be placed on a surface that is angled relative to the support surface. The contact surface is configured to engage a door to inhibit the door from moving in a first direction. The footrest extends from the main body. The footrest is configured to receive a force directed toward to the surface to inhibit the door from moving in a second direction that is opposite the first direction.

In some aspects, the footrest is configured to extend through a gap between a bottom of the door and the support surface such that the main body is configured to engage the door on one side of the door and the footrest is configured to receive the force on an opposite side of the door. In further aspects, the footrest is movably coupled to the main body. In further aspects, the footrest is integrally formed as a single piece with the main body.

Other aspects of the disclosure will become apparent by consideration of the detailed description and accompanying drawings.

### BRIEF DESCRIPTION OF THE DRAWINGS

FIG. 1 is a perspective view of a door stabilizer in accordance with an embodiment of the disclosure, illustrating the door stabilizer in a deployed position.

FIG. 2 is a perspective view of the door stabilizer of FIG. 1, illustrating the door stabilizer in a stowed position.

FIG. 3 is a perspective view of the door stabilizer of FIG. 1, illustrating the door stabilizer in use in the deployed position.

FIG. 4 is a perspective view of the door stabilizer of FIG. 1, illustrating the door stabilizer in use in the stowed position.

FIG. 5 is a perspective view of a door stabilizer in accordance with an embodiment of the disclosure.

FIG. 6 is a top perspective view of a door stabilizer in accordance with an embodiment of the disclosure, illustrating the door stabilizer in a deployed position.

FIG. 7 is a side view of the door stabilizer of FIG. 6, illustrating the door stabilizer in the deployed position.

FIG. 8 is a top view of the door stabilizer of FIG. 6, illustrating the door stabilizer in the deployed position.

FIG. 9 is a bottom view of a main body of the door stabilizer of FIG. 6.

FIG. 10 is a section view of a portion of the main body of FIG. 9 taken along line 10-10.

FIG. 11 is a section view of a portion of the door stabilizer of FIG. 6 taken along line 11-11.

FIG. 12 is a bottom perspective view of the door stabilizer of FIG. 6, illustrating the door stabilizer in a stowed position.

FIG. 13A is a front perspective view of the door stabilizer of FIG. 6, illustrating the door stabilizer in the stowed position.

FIG. 13B is a rear perspective view of the door stabilizer of FIG. 6, illustrating the door stabilizer in the stowed position.

FIG. 14 is a perspective view of the door stabilizer of FIG. 6, illustrating the door stabilizer in use in the deployed position.

FIG. 15 is another perspective view of the door stabilizer of FIG. 6, illustrating the door stabilizer in use in the deployed position.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

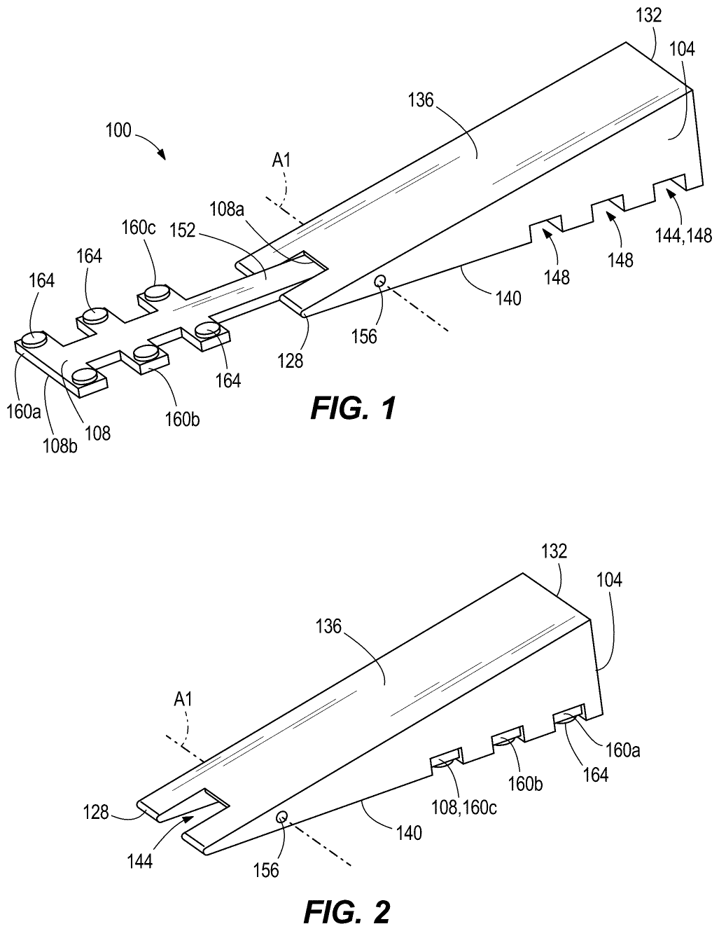

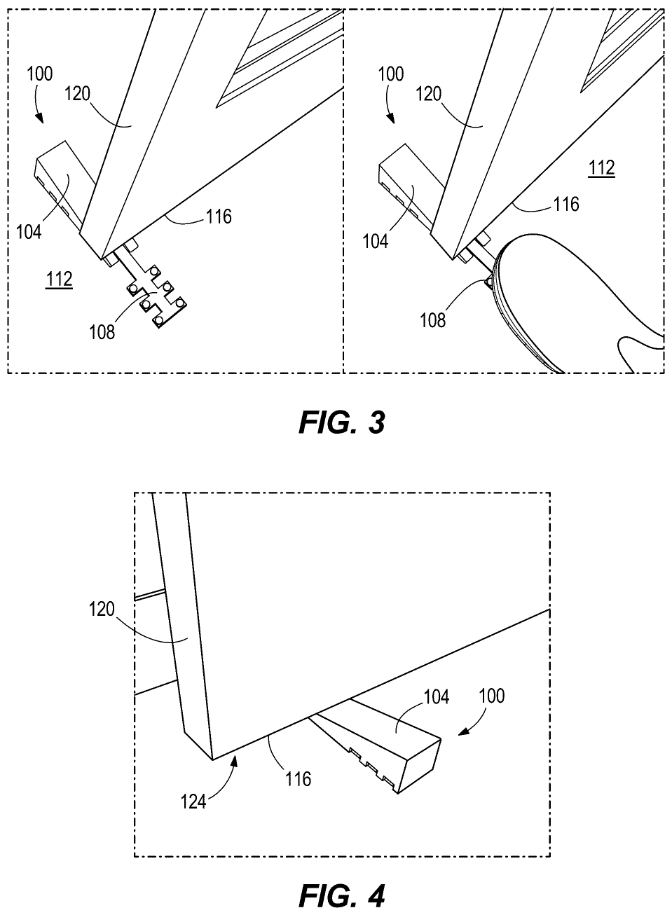

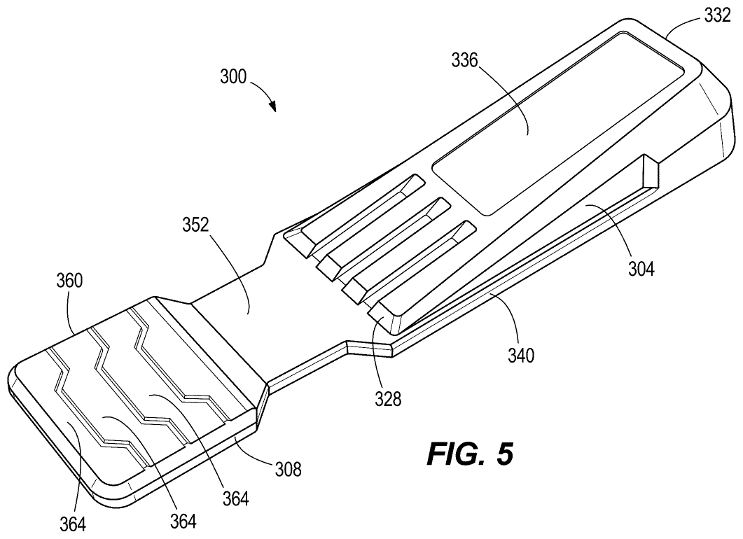

FIG. 1 illustrates a door stabilizer 100 according to an embodiment of the disclosure. The door stabilizer 100 includes a main body 104 and a footrest 108 movably (e.g., pivotably) coupled to the main body 104. The door stabilizer 100 is configured to be placed on a surface 112 (e.g., a ground surface) and to interface with a bottom 116 of a door 120 to inhibit the door 120 from moving relative to the surface 112. Generally, the main body 104 of the door stabilizer 100 is placed within a gap 124 (best illustrated in FIG. 4) defined between the bottom 116 of the door 120 and the surface 112.

With reference to FIGS. 1 and 2, the main body 104 is wedge-shaped and includes a first end 128, a second end 132, a contact surface 136, and a support surface 140. The main body 104 additionally defines a footrest receptacle 144. The contact surface 136, or upper surface, extends between the first end 128 and the second end 132 and is configured to interface with the bottom 116 of the door 120. In the illustrated embodiment, the contact surface 136 is graded (i.e., sloped) upward from the first end 128 to the second end 132. In other embodiments, the contact surface 136 may be curved such that the contact surface 136 curves upward from the first end 128 to the second end 132. The support surface 140, or lower surface, extends from the first end 128 to the second end 132 and is configured to interface with the surface 112. The support surface 140 is planar, or flat. As such, the contact surface 136 grades away from the support surface 140 between the first end 128 and the second end 132. That is, the contact surface 136 is closest to the support surface 140 at the first end 128, and the contact surface 136 is furthest from the support surface 140 at the second end 132.

The main body 104 defines the footrest receptacle 144 along the support surface 140. Specifically, the footrest receptacle 144 is defined along the support surface 140 from the first end 128 to the second end 132. The footrest receptacle 144 is a recess formed in the support surface 140. In other embodiments, the footrest receptacle 144 may be defined along the contact surface 136. In the illustrated embodiment, the footrest receptacle 144 is shaped complementarily to the footrest 108. As such, the footrest receptacle 144 includes a plurality of branch portions 148. The plurality of branch portions 148 is defined in the main body 104 at a position relatively closer to the second end 132 than the first end 128. In the illustrated embodiment, the main body 104 defines three branch portions 148. In other embodiments, the main body 104 may define more or fewer branch portions 148. Each of the plurality of branch of portions 148 is configured to receive a portion the footrest 108.

In the illustrated embodiment, the main body 104 of the door stabilizer 100 is formed of rubber or another similar type of flexible material. As such, the main body 104 is flexible such that the main body 104 may flex when engaged with the door 120. In other embodiments, the door stabilizer 100 may be formed of a plastic or another similar type rigid material such that the door stabilizer 100 is rigid.

With reference to FIGS. 1 and 2, the footrest 108, or extension, is movable relative to the main body 104 between a first or deployed position (e.g., FIG. 1) and a second or stowed position (e.g., FIG. 2). In the illustrated embodiment, the footrest 108 is pivotable between the deployed position and the stowed position. In other embodiments, the footrest 108 may be movable in other manners relative to the main body 104 between the deployed position and the stowed position. For example, the footrest 108 may be linearly slidable, rotatable sideways, foldable, telescope-able, or the like between the deployed position and the stowed position. The footrest 108 includes a tongue portion 152, a pivot shaft 156, and a plurality of branches 160a-160c. The pivot shaft 156 extends through the main body 104 and the tongue portion 152 to pivotably couple the footrest 108 to the main body 104. As such, the pivot shaft 156 defines a pivot axis A1 about which the footrest 108 pivots, or alternatively, rotates. The tongue portion 152 is a linear segment of the footrest 108 that extends from one end 108a of the footrest 108 (i.e., where the pivot shaft 156 is coupled) to the other end 108b of the footrest 108. Each of the plurality of branches 160a-160c extends outwardly from the tongue portion 152. Specifically, each of the plurality of branches 160a-160c extends perpendicularly from the tongue portion 152 and in both directions extending perpendicularly away from the tongue portion 152. In the illustrated embodiment, the footrest 108 includes three branches 160a-160c. In other embodiments, the footrest 108 may include more or fewer branches 160a-160c. Each one of the plurality of branches 160a-160c is spaced from the other branches 160a-160c. Specifically, a first branch 160a is positioned at the end 108b of the footrest 108 opposite from the pivot shaft 156, a second branch 160b is spaced along the tongue portion 152 from the first branch 160a in a direction extending toward the pivot shaft 156, and a third branch 160c is spaced from the second branch 160b in a direction extending toward the pivot shaft 156. Each of the branches 160a-160c includes a protrusion 164 at each end of the branch 160a-160c. The branches 160a-160c and the protrusions 164 provide traction for the foot of a user when a user steps on the footrest 108.

In the deployed position, as illustrated in FIG. 1, the footrest 108 extends outward from the main body 104 and increases an overall length of the door stabilizer 100. In the stowed position, as illustrated in FIG. 2, the footrest 108 is folded toward the main body 104 and disposed or stored within the footrest receptacle 144. The footrest 108 may be secured within the footrest receptacle 144 via a snap-fit, press-fit, ball detent, magnetic, or other similar type of quick-disconnect mechanism. The footrest receptacle 144 is formed on the support surface 140, such that the footrest 108 is flush or sub-flush with the support surface 140 when the footrest 108 is in the stowed position. By moving the footrest 108 to the stowed position, the overall length of the door stabilizer 100 decreases.

In the illustrated embodiment, the main body 104 and the footrest 108 are composed of the same material. Specifically, the main body 104 and the footrest 108 are each formed of a rubber material. In other embodiments, the main body 104 and the footrest 108 may be composed of different materials. For example, the main body 104 may be formed of a rubber material, and the footrest 108 may be formed of a plastic material. Alternatively, the main body 104 may be formed of a rubber material, and the footrest 108 may be formed of a plastic material.

With reference to FIGS. 3 and 4, in use of the door stabilizer 100, a user may first adjust the footrest 108 to the deployed position. The user may then slide the door stabilizer 100 under the door 120 such that the main body 104, and more specifically, the contact surface 136, interfaces with the bottom 116 of the door 120. With the main body 104 wedged in the gap 124 between the door 120 and the surface 112, the footrest 108 extends outward from the door 120, thereby allowing a user to step on the footrest 108 to inhibit the door stabilizer 100 and the door 120 from moving. This configuration advantageously allows a user to hold the door 120 steady while both hands remain free. For example, a typical door wedge only inhibits a door from moving in a single direction (i.e., toward the door stop). As such, the door stabilizer 100 advantageously enables a user to maintain a door in a stationary position (i.e., stationary in multiple directions) without the use of hands while working on the door (e.g., drilling a cross bore, a door handle bore, adjusting hinges, cleaning, etc.). As illustrated in FIG. 4, the door stabilizer 100 can also be utilized as a typical door stop wedge if desired. To do so, a user may adjust the footrest 108 to the stowed position. A user may then wedge the door stabilizer 100 beneath the door 120 such that the door stabilizer 100 performs like a typical door stop wedge to prop the door 120 open without user engagement with the door stabilizer 100 or the door 120.

FIG. 5 illustrates a door stabilizer 300 in accordance with another embodiment of the disclosure. The door stabilizer 300 is similar to the door stabilizer 100 except with no moving parts. Similar components are given like reference numerals, plus “200”. The differences are described below.

The door stabilizer 300 includes a main body 304 and a footrest 308. The main body 304 and the footrest 308 are integrally formed as a single piece. As such, the door stabilizer 300 is a monolithic structure. In some embodiments, the main body 304 and the footrest 308 may be separate pieces or components that are permanently, semi-permanently, or releasably coupled together. The main body 304 is wedge-shaped and includes a first end 328, a second end 332, a contact surface 336, and a support surface 340. The contact surface 336, or upper surface, extends between the first end 328 and the second end 332 and is configured to interface with a bottom of a door (e.g., the bottom 116 of the door 120 illustrated in FIG. 4). In the illustrated embodiment, the contact surface 336 is graded (i.e., sloped) upward from the first end 328 to the second end 332. In other embodiments, the contact surface 336 may be curved such that the contact surface 336 curves upward from the first end 328 to the second end 332. The support surface 340, or lower surface, extends from the first end 328 to the second end 332 and is configured to interface with a ground surface. The support surface 340 is planar, or flat. As such, the contact surface 336 grades away from the support surface 340 between the first end 328 and the second end 332. That is, the contact surface 336 is closest to the support surface 340 at the first end 328, and the contact surface 336 is furthest from the support surface 340 at the second end 332.

The footrest 108, or extension, includes a tongue portion 352 and a traction portion 360. In the illustrated embodiment, both the tongue portion 352 and the traction portion 360 are integrally formed with the main body 304. In other embodiments, just the tongue portion 352 may be integrally formed with the main body 304 such that the traction portion 360 is formed separately and is removably attached to the tongue portion 352. The traction portion 360 has a substantially square shape and includes a plurality of grip pads 364. In the illustrated embodiment, the traction portion 360 includes three grip pads 364. In other embodiments, the traction portion 360 may include fewer or more grip pads 364. The grip pads 364 may provide improved traction for the foot of a user when a user steps on the footrest 308.

In the illustrated embodiment, the door stabilizer 300 is flexible and formed of a rubber or another similar type flexible material. Specifically, both the main body 304 and the footrest 308 are formed of a flexible material. In other embodiments, the door stabilizer 300 is rigid and composed of a plastic or another similar type rigid material. Specifically, both the main body 304 and the footrest 308 are formed of a rigid material.

In use, the door stabilizer 300 is slid under a door (e.g., the door 120 of FIG. 3). The main body 304 is moved into contact with the door, such that the contact surface 320 is interfaced with the bottom of the door. At this point, the footrest 308 extends outward from the door to allow a user to step on the footrest 308 to inhibit the door stop 300 from moving. With the main body 304 wedged against one side of the door and a foot of the user against the other side of the door, the door stabilizer 100 (and therefore the door) is inhibited from moving.

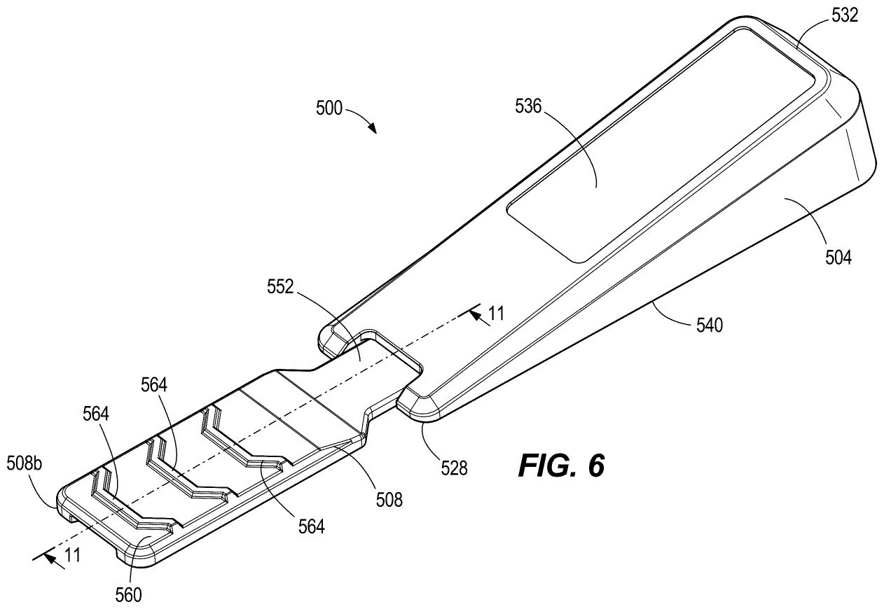

FIG. 6 illustrates a door stabilizer 500 in accordance with another embodiment. The door stabilizer 500 is similar to the door stabilizer 100 with differences described below. Similar components are given like reference numerals, plus “400”.

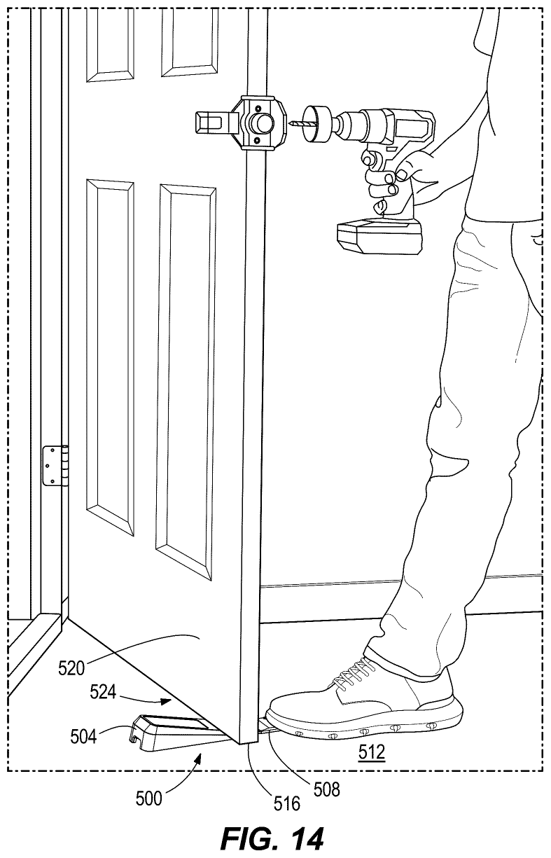

With reference to FIGS. 6 and 14, the door stabilizer 500 includes a main body 504 and a footrest 508 movably (e.g., pivotably, slidably, rotatably, foldably, telescopically, etc.) coupled to the main body 504. The door stabilizer 500 is configured to be placed on a surface 512 (e.g., a ground surface) and to interface with a bottom 516 of a door 520 to inhibit the door 520 from moving relative to the surface 512. Generally, the main body 504 of the door stabilizer 500 is placed within a gap 524 defined between the bottom 516 of the door 520 and the surface 512. The door stabilizer 500 advantageously enables a user to maintain a door 520 (FIG. 14) in a stationary position without the use of hands while working on the door 520 (e.g., drilling a cross bore, a door handle bore, adjusting hinges, cleaning, etc.), as described in more detail below.

With reference to FIGS. 6-8, the main body 504 is wedge-shaped and includes a first end 528, a second end 532, a contact surface 536, and a support surface 540. The main body 504 additionally defines a footrest receptacle 544. The contact surface 536, or upper surface, extends between the first end 528 and the second end 532 and is configured to interface with the bottom 516 of the door 520 (FIG. 14). In the illustrated embodiment, the contact surface 536 is graded (i.e., sloped) upward from the first end 528 to the second end 532. In other embodiments, the contact surface 536 may be curved such that the contact surface 536 curves upward from the first end 528 to the second end 532. The support surface 540, or lower surface, extends from the first end 528 to the second end 532 and is configured to interface with the surface 512. The support surface 540 is planar, or flat. As such, the contact surface 536 grades away from the support surface 540 between the first end 528 and the second end 532. That is, the contact surface 536 is closest to the support surface 540 at the first end 528, and the contact surface 536 is further from the support surface 540 at the second end 532. Stated another way, the contact surface 536 is angled relative to the support surface 540.

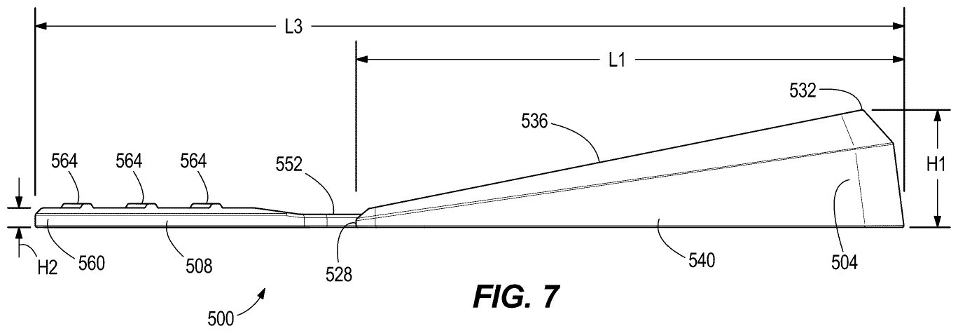

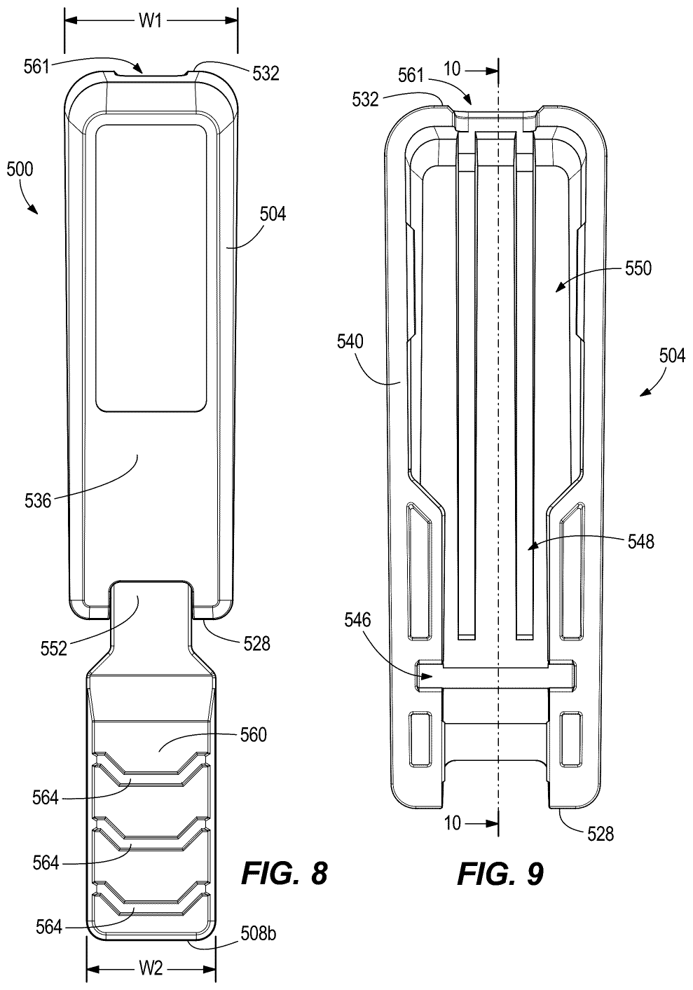

As illustrated in FIGS. 7 and 8, the main body 504 has a body height H1, a body length L1, and a body width W1. The body height H1 is taken at the second end 532 of the main body 504 such that the body height H1 is a maximum height of the main body 504. In the illustrated embodiment, the body height H1 is greater than a height of the gap 524 between the door 520 and the surface 512. As such, the contact surface 536 is configured to engage the door 520 at a position located between the first end 528 and the second end 532 of the main body 504. Specifically, the contact surface 536 may be configured to engage the door 520 at a position between the first end 528 and the second end 532 where a height of the main body 504 is equal to a height of the gap 524.

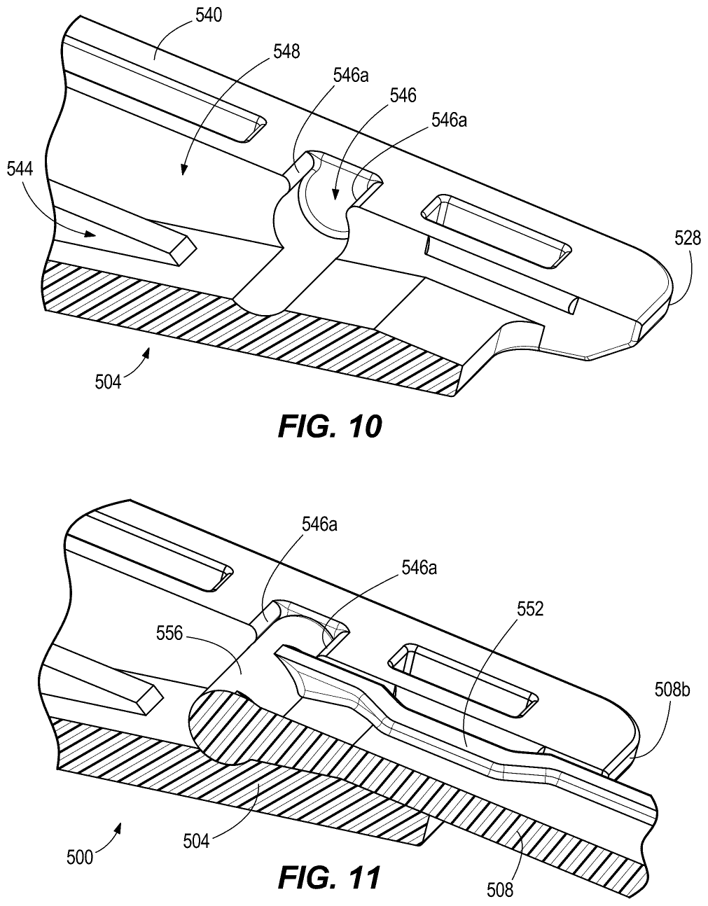

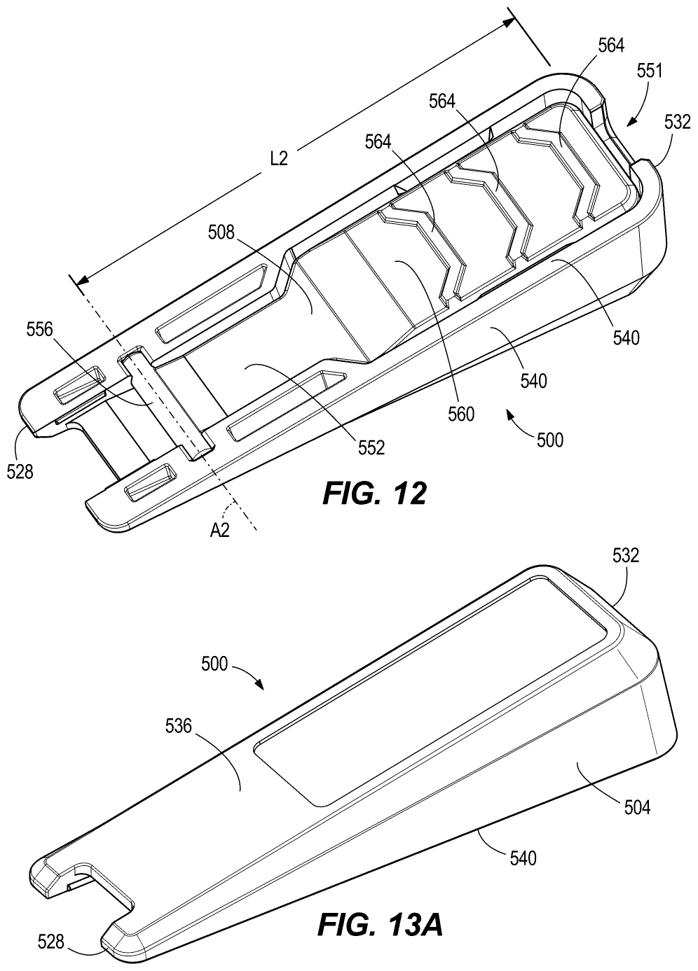

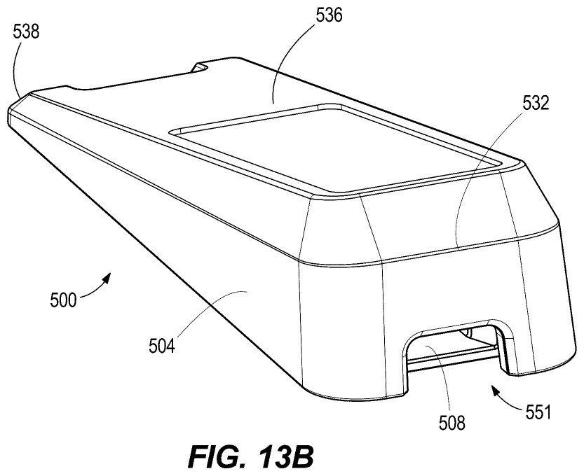

As illustrated in FIG. 9, the footrest receptacle 544 is defined in the main body 504 between the contact surface 536 and the support surface 540. The footrest receptacle 544 is a recess formed in the support surface 540. In other embodiments, the footrest receptacle 544 may be a recess formed in the contact surface 536 or a slot formed between the contact surface 536 and the support surface 540. The support surface 540 defines an opening to the footrest receptacle 544 between the first end 528 and the second end 532 of the main body 504. In the illustrated embodiment, the footrest receptacle 544 is shaped complimentarily to the footrest 508. As such, the footrest receptacle 544 includes a pivot shaft receptacle portion 546, a tongue receptacle portion 548 that is substantially rectangular in shape, and a grip receptacle portion 552 that is substantially rectangular in shape. With reference to FIGS. 10 and 11, the pivot shaft receptacle portion 546 is substantially circular in shape and includes protrusions 546a formed along the support surface 540 such that at least a portion of the pivot shaft receptacle portion 546 undercuts each of the protrusions 546a. In the illustrated embodiment, the pivot shaft receptacle portion 546 is spaced from the first end 228 of the main body 504. With reference to FIGS. 12 and 13B, the main body 504 further defines an aperture 561 at the second end 532 of the main body 504 that provides access to the footrest receptacle 544. Specifically, the aperture 561 allows a finger of a user to access the footrest receptacle 544. The main body 504 defines the aperture 561 such that the aperture 561 provides access to the footrest receptacle 544 while the support surface 540 is positioned on the surface 512 (FIG. 14). Additionally, the aperture 561 advantageously improves the ease with which a user can remove the footrest 508 from the footrest receptacle 544 (i.e., in order to adjust the footrest 508 from a stowed position to a deployed position, as will be described in more detail).

In some embodiments, the main body of the door stabilizer 500 is formed of rubber or another similar type of flexible material. As such, the main body 504 is flexible such that the main body 504 may flex when engaged with the door 120 (FIG. 14). In other embodiments, the door stabilizer 500 may be formed of a plastic or another similar type of rigid material such that the door stabilizer 500 is rigid.

With reference to FIGS. 6 and 12, the footrest 508, or extension is moveable (e.g., pivotable) relative to the main body 504 between a deployed position (FIG. 6) and a stowed position (FIGS. 12-13B). As illustrated in FIGS. 11 and 12, the footrest includes a tongue portion 552, a pivot shaft 556, and a grip portion 560. The pivot shaft 556 extends through a portion of the main body 504 to pivotably couple the footrest 508 to the main body 504. Specifically, the pivot shaft 556 is received in the pivot shaft receptacle portion 546. The protrusions 546a formed along the support surface 540 retain the pivot shaft 556 within the pivot shaft receptacle portion 546. In the illustrated embodiment, the pivot shaft 556 is coupled to the main body 504 via a snap-fit. In other embodiments, the pivot shaft 556 may be coupled to the main body 504 via other means. The pivot shaft 556 defines a pivot axis A2 about which the footrest 508 pivots, or alternatively, rotates. The tongue portion 552 is a rectangular segment of the footrest 508 that extends from one end 508a of the footrest 508 (i.e., from the pivot shaft 556) to the grip portion 560. The grip portion 560 defines an end 508b of the footrest 508 opposite from the pivot shaft 556. The grip portion 560 includes a plurality of grips, or protrusions 564, that protrude away from the footrest 508. That is, when the footrest 508 is in the deployed position for example, the protrusions 564 protrude from the footrest 508 in a direction extending away from the support surface 540. The protrusions 564 provide traction for the foot of a user when a user steps on the footrest 508. In the illustrated embodiment, the grip portion 560 has a substantially square shape. As such, the tongue portion 552 and the grip portion 560 have different dimensions.

With reference to FIGS. 7 and 8, the footrest 508 includes a footrest height H2, a footrest length L2 (FIG. 12), and a footrest width W2. In the illustrated embodiment, the footrest height H2 may be substantially the same as a height of the main body 504 at the first end 528 of the main body 504. The footrest length L2 is smaller than the body length L1. The footrest width W2 is less than the body width W2. As such, the dimensions of the footrest 508 enable the footrest 508 to fit within an outer boundary of the main body 504 (i.e., as defined by the body height H1, the body length L1, and the body width W1). In other words, the main body 504 and the footrest 508 are sized such that the footrest 508 fits entirely within the outer boundary of the main body 504 when the footrest 508 pivots into the footrest receptacle 544.

In the deployed position, as illustrated in FIGS. 6 and 7, the footrest 508 extends outward from the main body 504 and increases an overall length L3 of the door stabilizer 500. In the stowed position, as illustrated in FIG. 12, the footrest 508 is folded toward the main body 504 and disposed within the footrest receptacle 544. The footrest 508 may be secured within the footrest receptacle 544 via a snap-fit, press-fit, ball detent, magnetic, or other similar type of quick-disconnect mechanism. The footrest receptacle 544 is disposed on the support surface 540, such that the footrest 508 is flush or sub-flush with the support surface 540 when the footrest 508 is in the stowed position. By moving the footrest 508 to the stowed position, the overall length L3 of the door stabilizer 500 decreases. Specifically, the overall length of the door stabilizer 500 with the footrest in the stowed position is the same as the body length L1 of the main body 504. In the illustrated embodiment, the overall length L3 of the door stabilizer 500 when the footrest 508 is in the deployed position is between 1.2 and 2 times longer than a length of the door stabilizer 500 when the footrest 508 is in the stowed position (i.e., the body length L1 of the main body 504). In some embodiments, the overall length L3 of the door stabilizer 500 when the footrest 508 is in the deployed position is between 1.4 and 1.8 times longer than a length of the door stabilizer 500 when the footrest 508 is in the stowed position (i.e., the body length L1 of the main body 504).

In the illustrated embodiment, the main body 504 and the footrest 508 may be composed of the same material. Specifically, the main body 504 and the footrest 508 are each formed of a rubber material. In other embodiments, the main body 504 and the footrest 508 may be composed of different materials. For example, the main body 504 may be formed of a rubber material, and the footrest 508 may be formed of a plastic material. Alternatively, the main body 504 may be formed of a rubber material, and the footrest 508 may be formed of a plastic material.

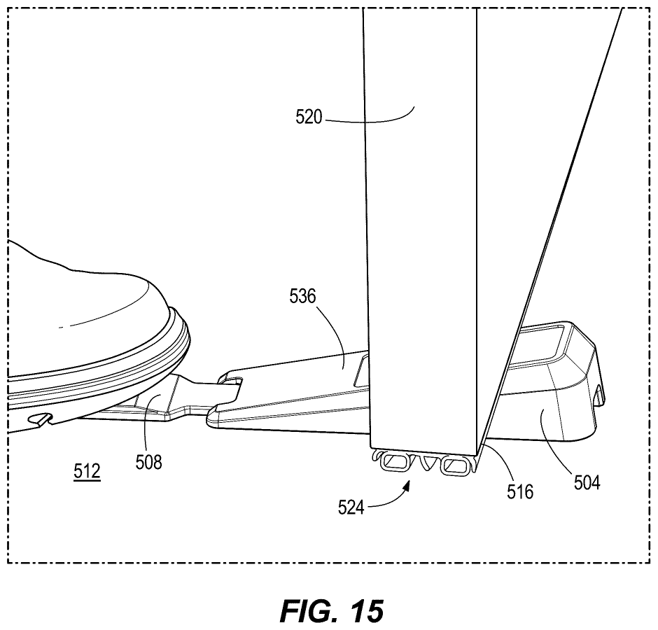

With reference to FIGS. 14 and 15, in use of the door stabilizer 500, a user may first adjust the footrest 508 to the deployed position. The user may then slide the door stabilizer 500 under the door 520 such that the main body 504, and more specifically, the contact surface 536, interfaces with the bottom 516 of the door 520. With the main body 504 wedged in the gap 524 between the door 520 and the surface 512, the contact surface 536 engages the door 520 on one side of the door 520, and the footrest 508 extends outward from the door 520 on an opposite side of the door 520, thereby allowing a user to step on the footrest 508 to inhibit movement of the door stabilizer 500 and the door 520. Although the use is described with respect to the use of the foot of a user, it is understood that any suitable force applied to the footrest 508 in the direction of the surface 512 that the door stabilizer 500 is positioned on has the same effect as the foot of a user. However, this configuration advantageously allows a user to hold the door 520 steady while both hands remain free. For example, a typical door wedge only inhibits a door from moving in a single direction (i.e., toward the door wedge). As such, a further advantage of the door stabilizer 500 is that the door stabilizer 500 enables a user to maintain a door 520 in a stationary position (i.e., stationary in multiple directions) without the use of hands while working on the door 520 (e.g., drilling a cross bore, a door handle bore, adjusting hinges, cleaning, etc.). The door stabilizer 500 can also be utilized as a typical door stop wedge if desired. To do so, a user may first adjust the footrest 508 to the stowed position. A user may then wedge the door stabilizer 500 beneath the door 520 such that the door stabilizer 500 performs like a typical door stop wedge to prop the door 520 open without user engagement with the door stabilizer 500 or the door 520.

Although the door stabilizer has been described in detail with reference to certain preferred embodiments, variations and modifications exist within the scope and spirit of one or more independent aspects of the disclosure as described. Various features and advantages of the disclosure are set forth in the following claims.

1. A door stabilizer comprising:
a main body defining a footrest receptacle and including
a first end,
a second end,
a support surface configured to be placed on a surface, the support surface extending between the first end and the second end, and
a contact surface configured to engage a door, the contact surface extending between the first end and the second end and extending away from the support surface such that the contact surface is further away from the support surface at the second end of the main body than at the first end of the main body; and
a footrest pivotably coupled to the main body, the footrest including a pivot shaft that defines a pivot axis about which the footrest pivots relative to the main body, at least a portion of the footrest configured to pivot into and out of the footrest receptacle.

2. The door stabilizer of claim 1, wherein the main body defines the footrest receptacle between the support surface and the contact surface, and wherein the support surface defines an opening to the footrest receptacle.

3. The door stabilizer of claim 2, wherein the footrest receptacle includes a pivot shaft receptacle portion, wherein protrusions are formed along the support surface at the pivot shaft receptacle portion, and wherein the protrusions engage the pivot shaft to retain the pivot shaft within the pivot shaft receptacle portion.

4. The door stabilizer of claim 1, wherein the main body and the footrest are sized such that the footrest fits entirely within an outer boundary of the main body when the footrest pivots into the footrest receptacle.

5. The door stabilizer of claim 1, wherein the footrest further includes a tongue portion extending from the pivot shaft and a grip portion at an end of the tongue portion opposite from the pivot shaft.

6. The door stabilizer of claim 5, wherein the grip portion includes a plurality of protrusions that improve traction of the footrest.

7. The door stabilizer of claim 5, wherein the footrest receptacle is complimentarily shaped to the footrest such that a portion of the footrest receptacle is shaped and sized to receive the tongue portion and another portion of the footrest receptacle is shaped and sized to receive the grip portion, and wherein the tongue portion and the grip portion have different dimensions.

8. The door stabilizer of claim 1, wherein the main body has a body length and a body width, wherein the footrest has a footrest length and a footrest width, and wherein the footrest length is less than the body length and the footrest width is less than the body width.

9. The door stabilizer of claim 1, wherein the contact surface slopes from the first end to the second end in a direction extending away from the support surface.

10. The door stabilizer of claim 1, wherein the main body defines an aperture at the second end of the main body that provides access to the footrest receptacle.

11. A door stabilizer comprising:
a main body including
a first end,
a second end,
a support surface configured to be placed on a surface, the support surface extending between the first end and the second end, and
a contact surface configured to engage a door, the contact surface extending between the first end and the second end; and
a footrest movably coupled to the main body, the footrest moveable between a stowed position, in which the door stabilizer is usable to inhibit movement of the door in one direction, and a deployed position, in which the door stabilizer is usable to inhibit movement of the door in multiple directions.

12. The door stabilizer of claim 11, wherein the main body defines a footrest receptacle that receives the footrest in the stowed position such that the footrest is positioned within the main body.

13. The door stabilizer of claim 12, wherein the footrest is positioned entirely within an outer boundary of the main body when the footrest is in the stowed position.

14. The door stabilizer of claim 12, wherein the main body defines an aperture at the second end of the main body, the aperture providing access to the footrest receptacle.

15. The door stabilizer of claim 11, wherein the footrest extends from the first end of the main body when the footrest is in the deployed position such that the footrest increases a length of the door stabilizer, and wherein the footrest is configured to extend through a gap between a bottom of the door and the surface when the footrest is in the deployed position.

16. The door stabilizer of claim 11, wherein a length of the door stabilizer when the footrest is in the deployed position is between 1.2 and 2 times longer than a length of the door stabilizer when the footrest is in the stowed position.

17. A door stabilizer comprising:
a main body including a support surface that is configured to be placed on a surface and a contact surface that is angled relative to the support surface, the contact surface configured to engage a door to inhibit the door from moving in a first direction; and
a footrest extending from the main body, the footrest configured to receive a force directed toward the surface to inhibit the door from moving in a second direction that is opposite the first direction.

18. The door stabilizer of claim 17, wherein the footrest is configured to extend through a gap between a bottom of the door and the surface such that the main body is configured to engage the door on one side of the door and the footrest is configured to receive the force on an opposite side of the door.

19. The door stabilizer of claim 18, wherein the footrest is movably coupled to the main body.

20. The door stabilizer of claim 18, wherein the footrest is integrally formed as a single piece with the main body.
